(19) United States
(12) Patent Application Publication
(10) Pub. No.: US 2026/0059633 A1
(43) Pub. Date: Feb. 26, 2026

(54) Lighting Control System, Method And Computer Program Product Thereof

(71) Applicant: AC Infinity Inc., Industry, CA (US)

(72) Inventors: Jimmy Liu, Brea, CA (US); Daniel Yu Hsu, Upland, CA (US); Wilbur Y. Cheng, Chino Hills, CA (US); Wei Ying Shao, Alhambra, CA (US)

(21) Appl. No.: 18/812,861

(22) Filed: Aug. 22, 2024

(51) Int. Cl. H05B 47/16; A01G 7/04

(52) U.S. Cl. CPC H05B 47/16; A01G 7/045

(57) ABSTRACT

A lighting control system for controlling grow lights includes a communication circuit and a processor. The processor is communicatively coupled to the communication circuit. The processor includes a computing unit and a control unit. The control unit is electrically coupled to the computing unit. The communication circuit can receive external parameters. The computing unit can determine light-on time and light-off time for the grow lights based on the external parameters and user-defined parameters. The control unit can generate a control signal for activating and deactivating the grow lights based on the light-on time and the light-off time. A method and a computer product thereof are also disclosed.

### FIELD OF THE INVENTION

The present invention generally relates to a lighting system and, more particularly, to a lighting control system for plants.

### BACKGROUND OF THE INVENTION

Numerous plants in nature necessitate particular environmental conditions, including specific light exposure durations, for robust growth. These plants exhibit varying prerequisites for light intensity and period. Some plants, unable to thrive solely on daylight, necessitate a controlled lighting system within grow houses. Overexposure or prolonged illumination can damage or impede flowering, while insufficient light can result in suboptimal nourishment.

However, traditional lighting systems demand manual intervention for toggling grow lights or relocating plants from indoors to outdoors to augment sunlight exposure.

### SUMMARY OF THE INVENTION

In order to overcome the disadvantages associated with the aforementioned systems, a lighting control system for controlling grow lights is disclosed. The lighting control system includes a communication circuit and a processor. The processor is communicatively coupled to the communication circuit. The processor includes a computing unit and a control unit. The control unit is electrically coupled to the computing unit. The communication circuit can receive external parameters. The computing unit can determine light-on time and light-off time for the grow lights based on the external parameters and user-defined parameters. The control unit can generate a control signal for activating and deactivating the grow lights based on the light-on time and the light-off time.

The lighting control system may be configured such that the computing unit can determine the light-on time and the light-off time by: calculating an average start time of the lowest average temperature period in first n 24-hour periods as Xₙ=(Tₓ₁+Tₓ₂+ . . . +Tₓₙ)/n; turning on the grow lights at Tₓₙ+aₙ₊₁ for a (n+1)-th 24-hour period if Xₙ>Tₓₙ; turning on the grow lights at Tₓₙ for the (n+1)-th 24-hour period if Xₙ=Tₓₙ; and turning on the grow lights at Tₓₙ−aₙ₊₁ for the (n+1)-th 24-hour period if Xₙ<Tₓₙ; and determining the user-defined parameters aₙ₊₁ as 1≤aₙ₊₁<|Tₓₙ−Tₓ₍ₙ₋₁₎| minutes, utilizing an absolute value of a difference between Tₓₙ and Tₓ₍ₙ₋₁₎, wherein Tₓₙ represents a start time of a lowest average temperature for a n-th 24-hour period, and Tₓ₍ₙ₋₁₎ represents a start time of a lowest average temperature for a (n−1)-th 24-hour period.

The lighting control system may be configured such that the external parameters can be measured by sensors that are communicatively coupled to the communication circuit and include temperature and humidity sensors.

The lighting control system may be configured such that the computing unit further derives a vapor pressure deficit parameter from temperature and humidity parameters. The external parameters include the temperature parameter, the humidity parameter, and the vapor pressure deficit parameter.

The lighting control system may be configured such that the control unit can implement a sunset sunrise setting, enabling the light control system to replicate gradual transitions of natural sunrise and sunset.

The lighting control system may be configured such that the computing unit can determine a duration of light exposure and an intensity of illumination based on a current growth stage of a plant exposed to the grow lights.

The lighting control system may further include sensors communicatively coupled to the communication circuit. The sensors can measure the external parameters.

The lighting control system may be configured such that the sensors include temperature and humidity sensors.

In another aspect, a method for controlling grow lights is provided. The method includes steps of receiving external parameters, determining light-on time and light-off time for the grow lights based on the external parameters and user-defined parameters, and generating a control signal for activating and deactivating the grow lights based on the light-on time and the light-off time.

The step of determining the light-on time and the light-off time may further include: calculating an average start time of the lowest average temperature period in first n 24-hour periods as Xₙ=(Tₓ₁+Tₓ₂+ . . . +Tₓₙ)/n; turning on the grow lights at Tₓₙ+aₙ₊₁ for a (n+1)-th 24-hour period if Xₙ>Tₓₙ; turning on the grow lights at Tₓₙ for the (n+1)-th 24-hour period if Xₙ=Tₓₙ; and turning on the grow lights at Tₓₙ−aₙ₊₁ for the (n+1)-th 24-hour period if Xₙ<Tₓₙ; and determining the user-defined parameters aₙ₊₁ as 1≤aₙ₊₁<|Tₓₙ−Tₓ₍ₙ₋₁₎| minutes, utilizing an absolute value of a difference between Tₓₙ and Tₓ₍ₙ₋₁₎, wherein Tₓₙ represents a start time of a lowest average temperature for a n-th 24-hour period, and Tₓ₍ₙ₋₁₎ represents a start time of a lowest average temperature for a (n−1)-th 24-hour period.

The step of determining the light-on time and the light-off time may further include determining the light-on time and the light-off time based on a time period during which lowest average temperature occurred within the past 24 hours.

The method may further include a step of deriving a vapor pressure deficit parameter from temperature and humidity parameters. The external parameters include the temperature parameter, the humidity parameter, and the vapor pressure deficit parameter.

The step of generating the control signal may further include activating and deactivating the grow lights using a sunset sunrise setting to replicate gradual transitions of natural sunrise and sunset.

The step of determining the light-on time and the light-off time may further include determining a duration of light exposure and an intensity of illumination based on a current growth stage of a plant exposed to the grow lights.

In a further aspect, a computer program product can be provided. The computer program product can include a computer readable storage medium readable by a processing circuit and storing instructions for execution by a processor for performing a method. The method includes steps of receiving external parameters, determining light-on time and light-off time for the grow lights based on the external parameters, and generating a control signal for activating and deactivating the grow lights based on the light-on time and the light-off time.

The step of determining the light-on time and the light-off time may further include: calculating an average start time of the lowest average temperature period in first n 24-hour periods as Xₙ=(Tₓ₁+Tₓ₂+ . . . +Tₓₙ)/n; turning on the grow lights at Tₓₙ+aₙ₊₁ for a (n+1)-th 24-hour period if Xₙ>Tₓₙ; turning on the grow lights at Tₓₙ for the (n+1)-th 24-hour period if Xₙ=Tₓₙ; and turning on the grow lights at Tₓₙ−aₙ₊₁ for the (n+1)-th 24-hour period if Xₙ<Tₓₙ; and determining the user-defined parameters aₙ₊₁ as 1≤aₙ₊₁<|Tₓₙ−Tₓ₍ₙ₋₁₎| minutes, utilizing an absolute value of a difference between Tₓₙ and Tₓ₍ₙ₋₁₎, wherein Tₓₙ represents a start time of a lowest average temperature for a n-th 24-hour period, and Tₓ₍ₙ₋₁₎ represents a start time of a lowest average temperature for a (n−1)-th 24-hour period.

The step of determining the light-on time and the light-off time may further include determining the light-on time and the light-off time based on a time period during which lowest average temperature occurred within the past 24 hours.

The method may further include a step of deriving a vapor pressure deficit parameter from temperature and humidity parameters. The external parameters include the temperature parameter, the humidity parameter, and the vapor pressure deficit parameter.

The step of generating the control signal may further include activating and deactivating the grow lights using a sunset sunrise setting to replicate gradual transitions of natural sunrise and sunset.

The step of determining the light-on time and the light-off time may further include determining a duration of light exposure and an intensity of illumination based on a current growth stage of a plant exposed to the grow lights.

### BRIEF DESCRIPTION OF THE DRAWINGS

The drawings illustrate examples. They do not illustrate all embodiments. Other embodiments may be used in addition or instead. Details that may be apparent or unnecessary may be omitted to save space or for more effective illustration. Some embodiments may be practiced with additional components or steps and/or without all of the components or steps that are illustrated. When the same numeral appears in different drawings, it refers to the same or like components or steps.

FIG. 1 shows a schematic diagram of an embodiment of a lighting control system.

FIG. 2 shows a schematic diagram of another embodiment of the lighting control system.

FIG. 3 shows a flowchart of an embodiment of a method for controlling grow lights.

### DETAILED DESCRIPTION OF THE PREFERRED EMBODIMENTS

Illustrative embodiments are now described. Other embodiments may be used in addition or instead. Details that may be apparent or unnecessary may be omitted to save space or for a more effective presentation. Some embodiments may be practiced with additional components or steps and/or without all of the components or steps that are described.

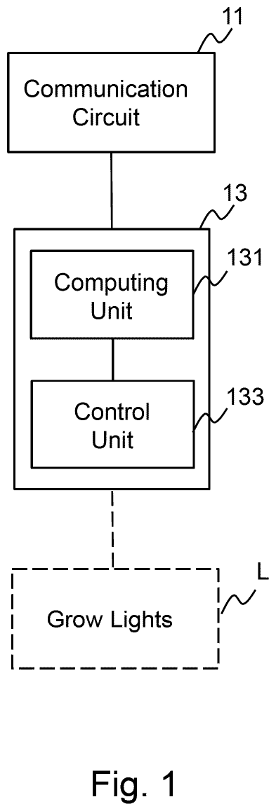

FIG. 1 shows a schematic diagram of an embodiment of a lighting control system. The lighting control system for controlling of grow lights L includes a communication circuit 11 and a processor 13. In this embodiment, the lighting control system is electrically connected to, but not limited to, the grow lights L. However, the lighting control system may be wirelessly connected to and manage the grow lights L.

In one embodiment, the communication circuit 11 can receive external parameters from an external database. For example, the communication circuit 11 can download the temperature and humidity data of the city in which it is located with the zip code (a system of postal codes used by the United States Postal Service) information. The external parameters include temperature, humidity, vapor pressure deficit and others that can affect the growth results of the plants under the illumination of the grow lights.

In some embodiments, the communication circuit 11 can be implemented using a wireless interface that includes an antenna receiver. Alternatively, the communication circuit 11 can be implemented using a wired interface that is connected to a local area network (LAN).

The processor 13 is communicatively coupled to the communication circuit 11. The processor 13 includes a computing unit 131 and a control unit 133. The control unit 133 is electrically coupled to the computing unit 131. In one embodiment, the processor 13 is electrically connected to the communication circuit 11. For example, smartphones or laptops have both the communication circuit 11 and the processor 13 integrated internally.

The computing unit 131 can determine light-on time and light-off time for the grow lights L based on the external parameters and user-defined parameters. The user-defined parameters may include a user-defined light-on duration T_{z} and parameters an. In an embodiment, at least one control algorithm is programmed into the computing unit 13. The control algorithm has the ability to improve lighting efficiency for different types of plants or different growth stages of a given plant in response to cyclical changes in environmental conditions.

In one embodiment, based on the user-defined light-on duration T_{z} and parameters an, the algorithm can determine the daily light-on time Tₓ and light-off time T_{y} by analyzing the outdoor climate sensor data from the previous 24 hours. Specifically, the computing unit 13 can use the external parameters from the past 24 hours along with the user-defined parameters to calculate the times, Tₓ and T_{y}. If less than 24 hours of data is available, the computing unit 13 can wait until 24 hours of data is collected before setting the optimal daily duration T_{z}. Once Tx and Ty are determined, the light is set to turn on from Tx to Ty for the next 24 hours, matching the optimal daily duration T_{z}. After this period, the process repeats by using the most recent 24 hours of external parameters to adjust Tₓ and T_{y} for the next period. The duration T_{z} can theoretically be set from 1 minute to 24 hours, with a recommended range of 1 to 14 hours. For example, if T_{z} is set to 8 hours, the computing unit 13 will identify the 8 consecutive hours with the lowest average temperature within the past 24 hours, wherein the start time of this 8-hour period is Tₓ, and the end time is T_{y}.

The duration of the lowest average external temperature in continuous 24-hour cycles is recorded using the smallest unit of time, which can be a minute. The time when the lowest average temperature first appears in the initial 24 hours is denoted as Tₓ₁, and the end time is T_{y1}. Similarly, the start and end times of the lowest average temperature in the next 24 hours are denoted as Tₓ₂ and T_{y2}, and so on. For the nth 24-hour period, these times are denoted as Tₓₙ and T_{yn}. In other words, the external parameters include the start time Tₓₙ and end time T_{yn} of the lowest average temperature during the nth 24-hour period.

To determine the optimal time to turn on the grow light, the computing unit 131 calculates the average start time of the lowest average temperature period in the first n 24-hour periods as Xₙ=(Tₓ₁+Tₓ₂+ . . . +Tₓₙ)/n. This average Xₙ is then compared with Tₓₙ. If Xₙ is later than Tₓₙ, i.e., Xₙ>Tₓₙ, the grow light will turn on at “Tₓₙ+aₙ₊₁” and off at “T_{yn}+aₙ₊₁” for the (n+1)-th 24-hour period. If Xₙ equals Tₓₙ, i.e., Xₙ=Tₓₙ, the grow light will turn on at Tₓₙ and off at T_{yn} for the (n+1)-th 24-hour period. If Xₙ is earlier than Tₓₙ, i.e., Xₙ<Tₓₙ, the grow light will turn on at Tₓₙ−aₙ₊₁ and off at “T_{yn}−aₙ₊₁” for the (n+1)-th 24-hour period.

The value of “aₙ” can be set by the user. A recommended an value can be 1≤aₙ<|Tₓ₍ₙ₋₁₎−Tₓ₍ₙ₋₂₎| minutes, utilizing the absolute value of the difference between Tₓ₍ₙ₋₁₎ and Tₓ₍ₙ₋₂₎. For example, the recommended value of a₃ is 1≤a₃<|Tₓ₂−Tₓ₁| minutes.

At the same time, record the start and end time of the lowest average temperature duration in the (n+1)-th 24 hours as Tₓ₍ₙ₊₁₎, T_{y(n+1)}. Compare Xₙ₊₁ and Tₓ₍ₙ₊₁₎ and decide the time to turn on the plant light in the (n+2)-th 24 hours according to the comparison results, and so on.

The following table summarizes the calculation process:

| | | Duration of | | | |
|---|---|---|---|---|---|
| | | Lowest | Calculation and | Lights On | Lights Off |
| NO. | Time | Temperature | Judgment | Time | Time |
| 1 | First 24- | Tₓ₁ − T_{y1} | / | / | / |
| | hours | | | | |
| 2 | Second | Tₓ₂ − T_{y2} | / | Tₓ₁ | T_{y1} |
| | 24-hours | | | | |
| 3 | Third | Tₓ₃ − T_{y3} | (Tₓ₁ + Tₓ₂)/2 > Tₓ₂ | Tₓ₂ + a₃ | T_{y2} + a₃ |
| | 24-hours | | (Tₓ₁ + Tₓ₂)/2 = Tₓ₂ | Tₓ₂ | T_{y2} |
| | | | (Tₓ₁ + Tₓ₂)/2 < Tₓ₂ | Tₓ₂ − a₃ | T_{y2} − a₃ |
| . . . | . . . | | | | |
| n | n-th 24 | Tₓₙ − T_{yn} | (Tₓ₁ + Tₓ₂ + . . . + | Tₓ₍ₙ₋₁₎ + aₙ | T_{y(n-1)} + aₙ |
| | hours | | Tₓ₍ₙ₋₁₎)/(n − 1) > Tₓ₍ₙ₋₁₎ | | |
| | | | (Tₓ₁ + Tₓ₂ + . . . + | Tₓ₍ₙ₋₁₎ | T_{y(n-1)} |
| | | | Tₓ₍ₙ₋₁₎)/(n − 1) = Tₓ₍ₙ₋₁₎ | | |
| | | | (Tₓ₁ + Tₓ₂ + . . . + | Tₓ₍ₙ₋₁₎ − aₙ | T_{y(n-1)} − aₙ |
| | | | Tₓ₍ₙ₋₁₎)/(n − 1) < Tₓ₍ₙ₋₁₎ | | |

As such, the exemplary algorithm ensures that changes in the light-on time and light-off time do not noticeably affect the plant's growth pattern, thereby preventing any negative impact due to the change in the light cycle.

The control unit 133 can generate a control signal for activating and deactivating the grow lights L based on the light-on time and light-off time. This allows the grow lights L to be turned on and off based on the control signal from the lighting control system, and the light exposure time of the plants can be optimized accordingly.

As such, the lighting control system dynamically regulates the activation time of grow lights for plants, considering various external parameters. It determines the optimal daily light exposure needed for indoor cultivation, accounting for factors like temperature and humidity over the 24-hour cycle. It achieves this by gathering relevant external parameters and using them to determine the ideal light exposure period. Additionally, the system functions effectively indoors by supplementing natural light. It synchronizes the grow light schedule with the outdoor environment, ensuring plants receive optimal light exposure at the most advantageous times. This approach not only creates a controlled environment for the grow space but also enhances energy efficiency by reducing unnecessary light usage.

In one embodiment, the control unit 133 can implement a sunset sunrise setting, enabling the light control system to replicate the gradual transitions of natural sunrise and sunset. During the scheduled sunrise period, light intensity begins to smoothly increases from the user-defined minimum level to the maximum level at the Tₓ moment, mirroring the natural progression of dawn. After continuous lighting, during the sunset period, light intensity gradually decreases from the maximum level to the minimum level, reaching the minimum level at the T_{y} moment, creating a tranquil sunset effect. The duration of sunrise and sunset periods can be set to be the same or different, with a recommended duration of 30 minutes to 1 hour for both sunrise and sunset. By mimicking natural light patterns, the system helps synchronize the internal clocks of plants, promoting healthier growth and development.

In one embodiment, the computing unit 131 can derive a vapor pressure deficit parameter from temperature and humidity parameters. The external parameters then include at least one of the temperature parameter, the humidity parameter, and the vapor pressure deficit parameter.

In one embodiment, the computing unit 131 can determine a duration of light exposure and an intensity of illumination for the grow lights L based on a current growth stage of a plant exposed to the grow lights L in response to changes in environmental conditions.

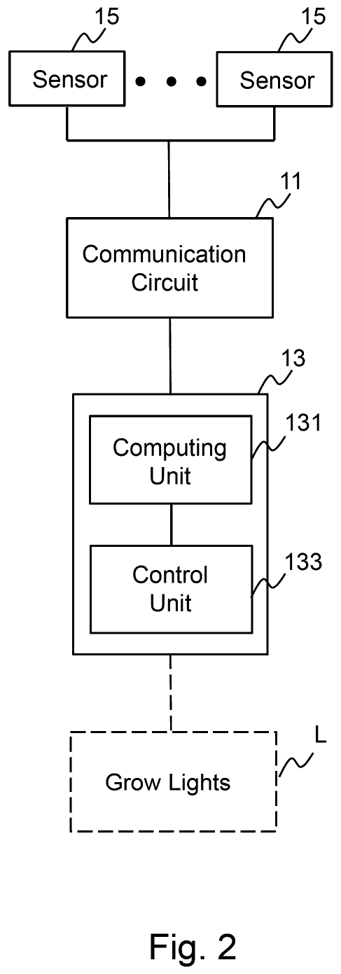

FIG. 2 shows a schematic diagram of another embodiment of the lighting control system. The lighting control system includes a communication circuit 11, a processor 13, and sensors 15. The technical features and the connections between the communication circuit 11 and the processor 13 are described in the aforementioned embodiments and will therefore not be repeated here.

The sensors 15 are communicatively coupled to the communication circuit 11. The sensors can measure the external parameters. In one embodiment, sensors 15 include temperature and humidity sensors. However, some sensors 15 may be integrated as a single sensor during manufacture and still fall within the scope of sensors 15 herein.

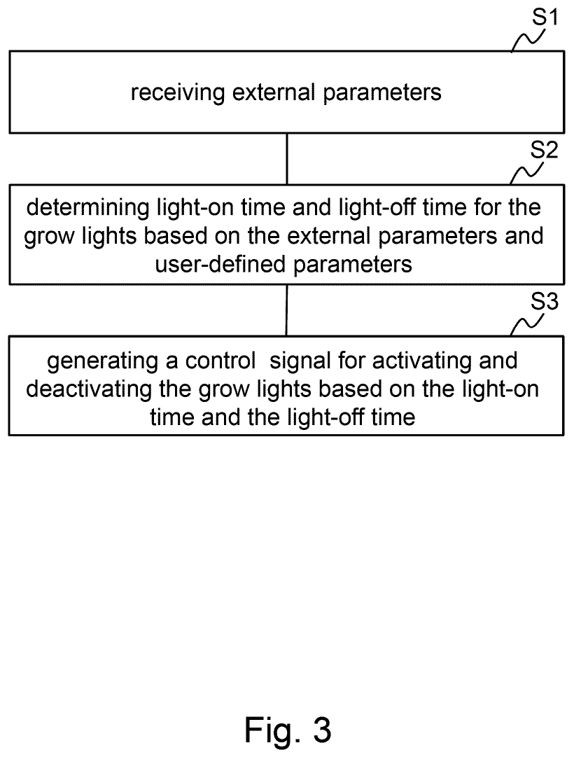

FIG. 3 shows a flowchart of an embodiment of a method for controlling grow lights. Referring to FIGS. 1 and 3 together, the method for controlling grow lights L includes:
step S1: receiving external parameters;
step S2: determining light-on time and light-off time for the grow lights based on the external parameters and user-defined parameters; and
step S3: generating a control signal for activating and deactivating the grow lights based on the light-on time and light-off time.

In one embodiment, the method may further include a step of deriving a vapor pressure deficit parameter from temperature and humidity parameters. The external parameters then include the temperature parameter, the humidity parameter, and the vapor pressure deficit parameter.

In one embodiment, the step of determining light on and off times may further include determining a duration of light exposure and an intensity of illumination based on a current growth stage of a plant exposed to the grow lights.

Referring to FIG. 2 again, in one embodiment, the method may further include, in addition to the embodiment shown in FIG. 3, a step of measuring the external parameters with sensors 15.

The aforementioned steps of the methods can be implemented through one or more embodiments of the lighting control systems mentioned above, thus avoiding redundant repetition of the technical function, results, and advantages.

In another embodiment, a computer program product can be provided. The computer program product can include a computer readable storage medium readable by a processing circuit and storing instructions for execution by a processor for performing one or more embodiments of the methods for controlling grow lights mentioned above. Thus, the technical function, results, and advantages are omitted here to avoid redundant repetition.

In one embodiment, the computer program product is an application software that can be downloaded from the Internet or other appropriate networks. This allows users to upgrade their software of an existing lighting system for plants to implement the method for controlling grow lights with the optimal daily light exposure for indoor growing as well as supplemental lighting for outdoor applications.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims, which are to be accorded with the broadest interpretation so as to encompass all such modifications and similar structures.

The terms and expressions used herein have the ordinary meaning accorded to such terms and expressions in their respective areas, except where specific meanings have been set forth. The terms “comprises,” “comprising,” and any other variation thereof when used in connection with a list of elements in the specification or claims are intended to indicate that the list is not exclusive and that other elements may be included. Similarly, an element proceeded by “a” or “an” does not, without further constraints, preclude the existence of additional elements of the identical type.

What is claimed is:

1. A lighting control system for controlling grow lights comprising:
a communication circuit for receiving external parameters; and
a processor communicatively coupled to the communication circuit and comprising:
a computing unit that can determine light-on time and light-off time for the grow lights based on the external parameters and user-defined parameters; and
a control unit electrically coupled to the computing unit and for generating a control signal for activating and deactivating the grow lights based on the light-on time and the light-off time.

2. The lighting control system of claim 1, wherein the computing unit can determine the light-on time and the light-off time by:
calculating an average start time of the lowest average temperature period in first n 24-hour periods as Xₙ=(Tₓ₁+Tₓ₂+ . . . +Tₓₙ)/n;
turning on the grow lights at Tₓₙ+aₙ₊₁ for a (n+1)-th 24-hour period if Xₙ>Tₓₙ;
turning on the grow lights at Tₓₙ for the (n+1)-th 24-hour period if Xₙ=Tₓₙ;
turning on the grow lights at Tₓₙ−aₙ₊₁ for the (n+1)-th 24-hour period if Xₙ<Tₓₙ; and
determining the user-defined parameters aₙ₊₁ as 1≤aₙ₋₁<|Tₓₙ−Tₓ₍ₙ₋₁₎| minutes, utilizing an absolute value of a difference between Tₓₙ and Tₓ₍ₙ₋₁₎, wherein Tₓₙ represents a start time of a lowest average temperature for a n-th 24-hour period, and Tₓ₍ₙ₋₁₎ represents a start time of a lowest average temperature for a (n−1)-th 24-hour period.

3. The lighting control system of claim 1, wherein the external parameters can be measured by sensors that are communicatively coupled to the communication circuit and include temperature and humidity sensors.

4. The lighting control system of claim 1, wherein the computing unit further derives a vapor pressure deficit parameter from temperature and humidity parameters, and wherein the external parameters comprise the temperature parameter, the humidity parameter, and the vapor pressure deficit parameter.

5. The lighting control system of claim 1, wherein the control unit can implement a sunset sunrise setting, enabling the light control system to replicate gradual transitions of natural sunrise and sunset.

6. The lighting control system of claim 1, wherein the computing unit can determine a duration of light exposure and an intensity of illumination based on a current growth stage of a plant exposed to the grow lights.

7. A method for controlling grow lights comprising:
receiving external parameters;
determining light-on time and light-off time for the grow lights based on the external parameters and user-defined parameters; and
generating a control signal for activating and deactivating the grow lights based on the light-on time and the light-off time.

8. The method of claim 7, wherein the step of determining the light-on time and the light-off time further comprises:
calculating an average start time of the lowest average temperature period in first n 24-hour periods Xₙ as Xₙ=(Tₓ₁+Tₓ₂+ . . . +Tₓₙ)/n;
turning on the grow lights at Tₓₙ+aₙ₊₁ for a (n+1)-th 24-hour period if Xₙ>Tₓₙ;
turning on the grow lights at Tₓₙ for the (n+1)-th 24-hour period if Xₙ=Tₓₙ; and
turning on the grow lights at Tₓₙ−aₙ₊₁ for the (n+1)-th 24-hour period if Xₙ<Tₓₙ; and
determining the user-defined parameters aₙ₊₁ as 1≤aₙ₊₁≤|Tₓₙ−Tₓ₍ₙ₋₁₎| minutes, utilizing an absolute value of a difference between Tₓₙ and Tₓ₍ₙ₋₁₎, wherein Tₓₙ represents a start time of a lowest average temperature for a n-th 24-hour period, and Tₓ₍ₙ₋₁₎ represents a start time of a lowest average temperature for a (n−1)-th 24-hour period.

9. The method of claim 7, wherein the step of determining the light-on time and the light-off time further comprises: determining the light-on time and the light-off time based on a time period during which lowest average temperature occurred within the past 24 hours.

10. The method of claim 7, further comprising:
deriving a vapor pressure deficit parameter from temperature and humidity parameters, wherein the external parameters comprise the temperature parameter, the humidity parameter, and the vapor pressure deficit parameter.

11. The method of claim 7, wherein the step of generating the control signal further comprises: activating and deactivating the grow lights using a sunset sunrise setting to replicate gradual transitions of natural sunrise and sunset.

12. The method of claim 7, wherein the step of determining the light-on time and the light-off time further comprises: determining a duration of light exposure and an intensity of illumination based on a current growth stage of a plant exposed to the grow lights.

13. A computer program product comprising:
a computer readable storage medium readable by a processing circuit and storing instructions for execution by a processor for performing a method comprising:
receiving external parameters;
determining light-on time and light-off time for the grow lights based on the external parameters; and
generating a control signal for activating and deactivating the grow lights based on the light-on time and the light-off time.

14. The computer program product of claim 13, wherein the step of determining the light-on time and the light-off time further comprises:
calculating an average start time of the lowest average temperature period in first n 24-hour periods Xₙ as Xₙ=(Tₓ₁+Tₓ₂+ . . . +Tₓₙ)/n;
turning on the grow lights at Tₓₙ+aₙ₊₁ for a (n+1)-th 24-hour period if Xₙ>Tₓₙ;
turning on the grow lights at Tₓₙ for the (n+1)-th 24-hour period if Xₙ=Tₓₙ;
turning on the grow lights at Tₓₙ−aₙ₊₁ for the (n+1)-th 24-hour period if Xₙ<Tₓₙ; and
determining the user-defined parameters aₙ₊₁ as 1≤aₙ₋₁<|Tₓₙ−Tₓ₍ₙ₋₁₎| minutes, utilizing an absolute value of a difference between Tₓₙ and Tₓ₍ₙ₋₁₎, wherein Tₓₙ represents a start time of a lowest average temperature for a n-th 24-hour period, and Tₓ₍ₙ₋₁₎ represents a start time of a lowest average temperature for a (n−1)-th 24-hour period.

15. The computer program product of claim 13, wherein the step of determining the light-on time and the light-off time further comprises:
determining the light-on time and the light-off time based on a time period during which lowest average temperature occurred within the past 24 hours.

16. The computer program product of claim 13, wherein the method further comprises:
deriving a vapor pressure deficit parameter from temperature and humidity parameters, wherein the external parameters comprise the temperature parameter, the humidity parameter, and the vapor pressure deficit parameter.

17. The computer program product of claim 13, wherein the step of generating the control signal further comprises: activating and deactivating the grow lights using a sunset sunrise setting to replicate gradual transitions of natural sunrise and sunset.

18. The computer program product of claim 13, wherein the step of determining the light-on time and the light-off time further comprises:
determining a duration of light exposure and an intensity of illumination based on a current growth stage of a plant exposed to the grow lights.
